(19) United States
(12) Patent Application Publication
(10) Pub. No.: US 2021/0199422 A1
(43) Pub. Date: Jul. 1, 2021

(54) MEASUREMENT SYSTEM FOR MEASURING AGGREGATE IN A CONTAINER

(71) Applicant: Garner Industries, Inc., Lincoln, NE (US)

(72) Inventors: Doug Hartzell, Omaha, NE (US); Mike Cradit, Omaha, NE (US)

(73) Assignee: Garner Industries, Inc., Lincoln, NE (US)

(21) Appl. No.: 17/137,649

(22) Filed: Dec. 30, 2020

Related U.S. Application Data
(60) Provisional application No. 62/955,028, filed on Dec. 30, 2019.

(51) Int. Cl. G01B 11/02; G01S 17/08

(52) U.S. Cl. CPC G01B 11/026; G01S 17/08

(57) ABSTRACT

A measurement system for accurate and reliable measurement of an aggregate in a container is described. As used herein “accurate” means the actual amount of aggregate in a container is approximately the same as the measured value of aggregate. As used herein “reliable” means the operation of the distance sensor for extended periods of time without maintenance or battery replacement and without requiring a larger power source. The measurement system includes a distance sensor, a gateway, and a network for accurately and reliably measuring an aggregate in a container over a long period of time (e.g. at least three years). The measurement system includes a distance sensor, a gateway, and a computer-based program.

### REFERENCE TO RELATED APPLICATIONS

This application claims the benefit of U.S. Provisional Application No. 62/955,028 entitled “MEASUREMENT SYSTEM FOR MEASURING AGGREGATE IN A CONTAINER” filed Dec. 30, 2019, which is incorporated by reference in its entirety.

### BACKGROUND

Accurate and reliable measuring of aggregate (e.g. grain, feed, corn, liquid) inside a holding container (e.g. a container), such as silos, grain bins, and the like is necessary for determining the rate of consumption. The rate of consumption provides important information for scheduling future orders and assessing whether consumption is on par with the needed rate. For example, in feeding livestock, the rate of consumption throughout the life of a load of aggregate in the container gives insight into whether the livestock are consuming too much, too little, or the appropriate amount of aggregate. However, obtaining these accurate and reliable measurements, without sacrificing container volume present obstacles.

One conventional method of measuring aggregate in a container is through ultrasonic technology, where sound waves are used to measure the distance from the ultrasonic device to the aggregate. Ultrasonic technology presents the issue of not obtaining accurate measurements due to false echoes within the container. Typically, these ultrasonic devices emit pulses at a wide beam angle, such that the corrugation of the container, coupled with the steep hopper and roof angles causes the sound waves to become “trapped” producing false echoes that are measured by the device.

Another conventional method of measuring aggregate is a cable based yo-yo system, where a weight is lowered on a cable until it reaches the aggregate, and the weight is then raised. The distance is measured by the amount of cable used to extend the weight to the aggregate. While this system may provide accurate measurements, it has the drawbacks of requiring a large power source (i.e. 100 VAC power), the units are typically large, and the units are prone to mechanical failures leading to decreased reliability.

Yet another conventional method to measure aggregate is radar systems. Radar systems require approximately 60.96 centimeters (24 inches) of dead space at the top of the container for an accurate measurement, which sacrifices container volume that could be utilized for storage space. Moreover, radar systems require large power sources to operate, decreasing their reliability.

Finally, conventional systems may utilize laser technology to take accurate measurements of aggregate within a container. These laser systems typically require low amounts of power, however, they face accuracy and other reliability issues. For example, a challenge to obtaining an accurate measurement is laser diffusion and laser obfuscation. When the aggregate is a solid, such as grain or corn, it creates dust particles. These dust particles cause diffusion of the laser, such that the laser cannot reach the aggregate for an accurate measurement. Moreover, dust or other environmental factors, such as spiders or spider webs, may settle on the laser (e.g. laser receiver window) causing laser obfuscation.

Conventional laser devices utilize additional mechanical means to combat this laser diffusion or obfuscation. Examples include creating a positive pressure environment surrounding the laser, which is only equalized when a measurement is being taken. This method introduces another mechanical aspect into the device, which may require maintenance or fail, reducing the reliability of the system. Another example of combatting this laser obfuscation is through a “windshield wiper” like apparatus that cleans the laser window removing dust particulate. Again this introduces a mechanical process, where maintenance and mechanical failures decrease reliability.

It is therefore desirable to have a device for measuring aggregate in a container that provides an accurate and reliable measurement. It is further desirable for the device to be safeguarded against environmental factures (e.g. dust particulate, spiders, and spider webs) from diffusing or obfuscating the laser.

### SUMMARY

In aspects of the invention, a distance sensor of a measurement system for accurate and reliable measurement of an aggregate in a container, includes: an enclosure configured to house a battery holder, batteries, a LoRa modem, a laser module and a CPU, the enclosure having a removably attached lid providing access to the battery holder, batteries, LoRa modem, laser module, and CPU, and a dust tube receiver; a dust tube, the dust tube comprising a mount receiver, an enclosure attachment, wherein the enclosure attachment of the dust tube is in removable attachment with the dust tube receiver of the enclosure; a diameter from 0.635 cm to 7.62 cm (0.25 to 3.0 inches), a length from 10.16 cm to 50.8 cm (4 to 20 inches), wherein a ratio of the length and the diameter is from 4:1 to 8:1; a mount configured to provide mechanical attachment to a roof of the container and mechanical attachment to the dust tube via the mount receiver; the laser module configured to measure the distance from the laser module to an aggregate of the container; the CPU configured to initiate the laser module to measure the distance from the laser module to the aggregate of the container and transmit the measure via a LoRa communicator, wherein the CPU is in electrical communication with the batteries and the CPU is communicatively coupled to the laser module and the LoRa communicator.

In other aspects of the invention the distance sensor of a measurement system for accurate and reliable measurement of an aggregate in a container, includes: an enclosure configured to house a battery holder, batteries, a LoRa modem, a laser module and a CPU, the enclosure having a dust tube receiver; a means for minimizing laser diffusion and preventing environmental factors from obfuscating the laser module, wherein the means is in removable attachment with the enclosure via the dust tube receiver; a mount configured to provide mechanical attachment to a roof of the container and mechanical attachment to the means via a mount receiver; the laser module configured to measure the distance from the laser module to an aggregate of the container; the CPU configured to initiate the laser module to measure the distance from the laser module to the aggregate of the container and transmit the measure via a LoRa communicator, wherein the CPU is in electrical communication with the batteries and the CPU is communicatively coupled to the laser module and the LoRa communicator.

A measurement system for accurate and reliable measurement of an aggregate in a container, including: a distance sensor, the distance sensor comprising, an enclosure configured to house a battery holder, batteries, a LoRa modem, a laser module and a CPU, the enclosure having a dust tube receiver; a means for minimizing laser diffusion and preventing environmental factors from obfuscating the laser module, wherein the means is in removable attachment with the enclosure via the dust tube receiver; a mount configured to provide mechanical attachment to a roof of the container and mechanical attachment to the means via a mount receiver; the laser module configured to measure the distance from the laser module to an aggregate of the container; the CPU configured to initiate the laser module to measure the distance from the laser module to the aggregate of the container and transmit the measure via a LoRa communicator, wherein the CPU is in electrical communication with the batteries and the CPU is communicatively coupled to the laser module and the LoRa communicator; a gateway configured to receive the measure from the LoRa communicator of the distance sensor, the gateway further configured to transmit the measure and a metadata set to a computer-based program via a network; the computer-based program configured for processing the measure and the metadata set.

### FIGURES

FIG. 1 represents a measurement system having a distance sensor, a gateway, and a network.

FIG. 1.a. represents a distance sensor network.

FIG. 2 represents a vertical cross section view of a distance sensor.

FIG. 3.a. represents an adjustable mount that is in a neutral position.

FIG. 3.b. represents an adjustable mount 124 that is in an adjusted position.

FIG. 3.c. represents a fixed mount 124.

FIG. 3.d. is a graphic representation of the position of a distance sensor in connection with a container.

FIG. 4a represents a distance sensor having a dust tube with a funnel shape.

FIG. 4b represents a distance sensor having a dust tube with a cylindrical shape.

FIG. 5 is a bottom-up view of a distance sensor having a dust tube attached.

### DETAILED DESCRIPTION

A measurement system for accurate and reliable measurement of an aggregate in a container is described. As used herein “accurate” means the actual amount of aggregate in a container is approximately the same as the measured value of aggregate. As used herein “reliable” means the operation of the distance sensor for extended periods of time without maintenance or battery replacement and without requiring a larger power source. The measurement system includes a distance sensor, a gateway, and a network for accurately and reliably measuring an aggregate in a container over a long period of time (e.g. at least three years). The measurement system includes a distance sensor, a gateway, and a computer-based program.

The distance sensor of the distance sensor system accurately and reliably measures the level of aggregate (each a “measurement”) up to 35 feet away, periodically over a long period of time by utilizing a laser module to measure distance and a dust tube to minimize laser diffusion and prevent environmental factors from obfuscating the laser. Once received by the distance sensor, each measurement along with its accompanying metadata is transmitted via a LoRa (long range) communicator to a gateway. The gateway transmits the measurements and metadata to a computer-based (e.g. online) program (e.g. via a website) for allowing further processing and display of the measurements and metadata.

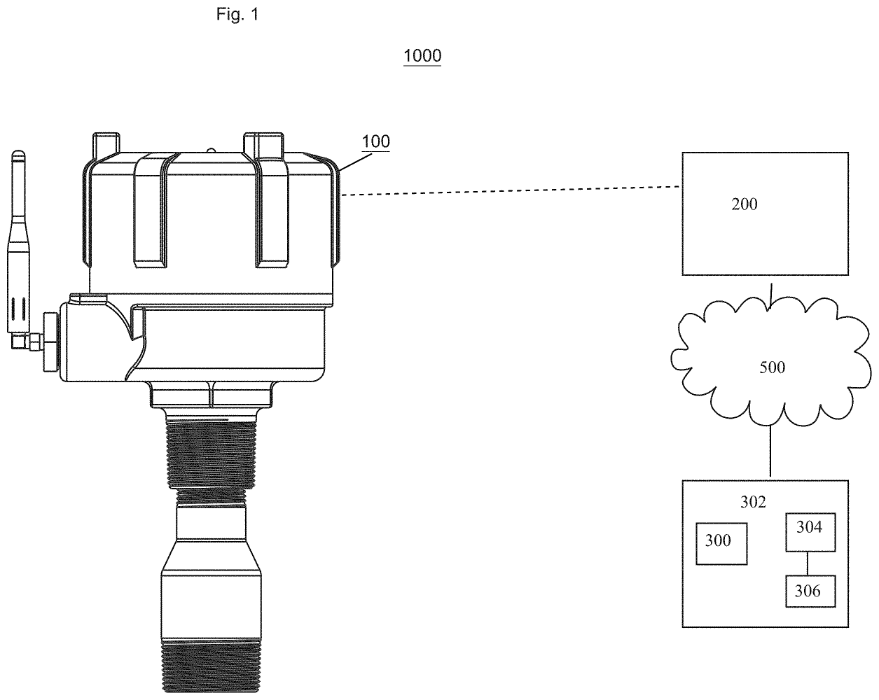

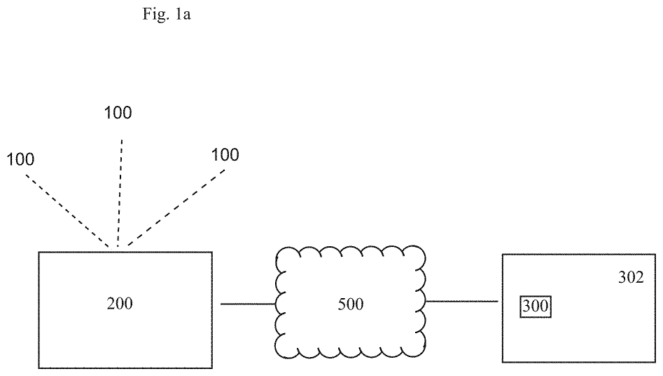

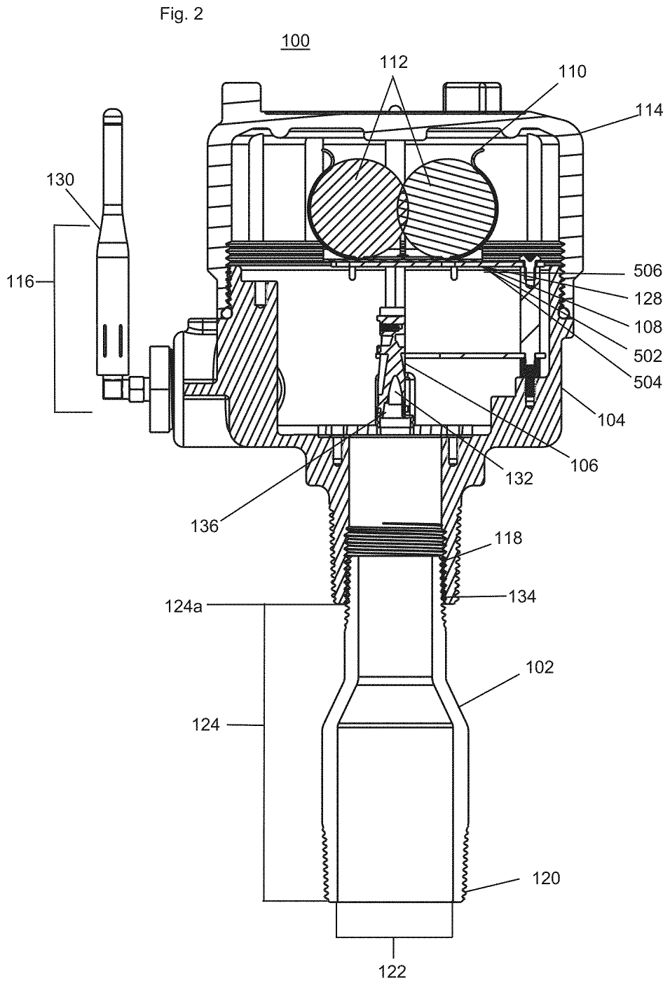

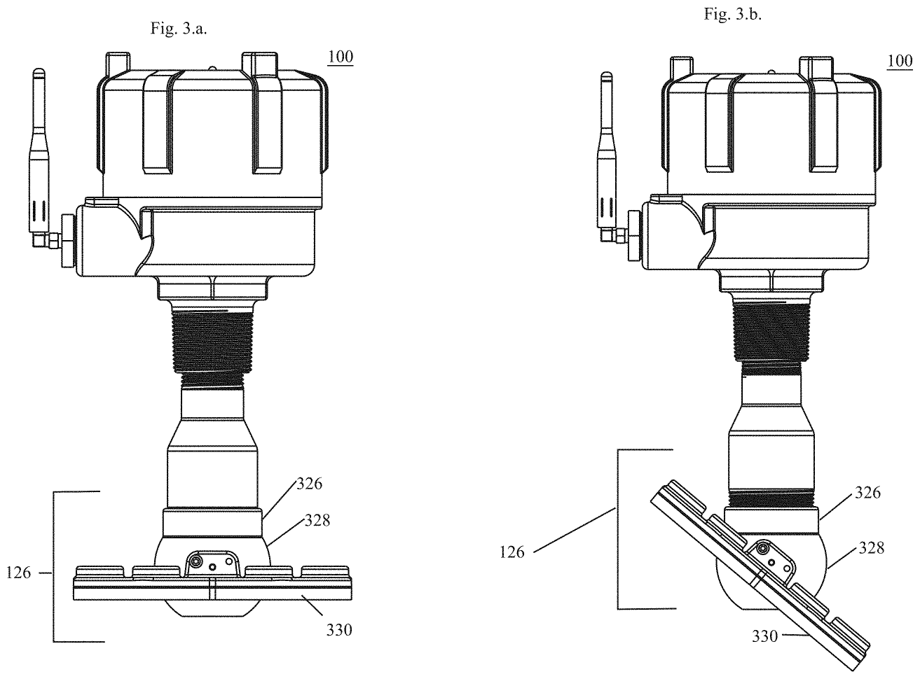

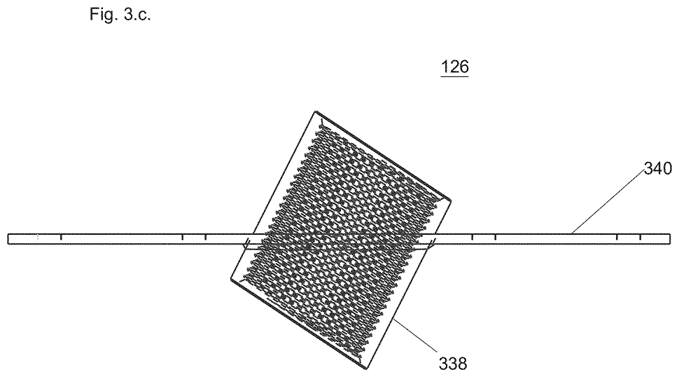

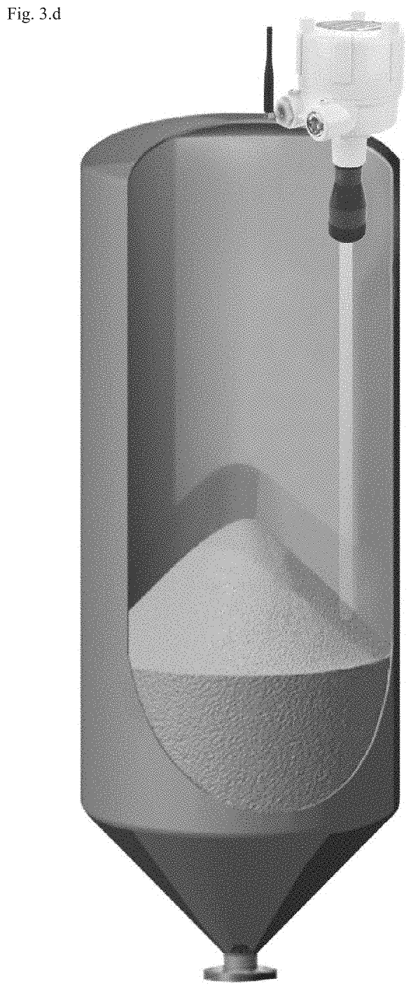

FIG. 1 represents a measurement system for accurate and reliable measurement of an aggregate in a container. The measurement system 1000 includes a distance sensor 100, a gateway 200, and a computer-based program 300. The measurement system 1000 may include a mount 126 (see FIGS. 3.a.-3.d.) for proper positioning of the distance sensor 100. The measurement system 1000 may include a plurality of distance sensors 100 making up a distance sensor network 400 as shown in FIG. 1.a. The distance sensor 100 (see FIG. 2) takes accurate and reliable measurements of the aggregate in the container. The distance sensor 100 transmits the measurement and a metadata set to the gateway 200. The gateway 200 transmits the measurement and the metadata set to the computer-based program 300 for display of the measurements and metadata.

The gateway 200 is configured for receipt and transmission of measurements and metadata from the distance sensor 100 and to the computer-based program 300, respectively. For example, the gateway acts as an intermediary that allows the distance sensor to transmit measurements and metadata to the computer-based program 300. The gateway 200 may be configured for receipt of measurements and metadata from the distance sensor network 400. The gateway 200 receives measurements from the distance sensor 100 via the LoRa radio frequency. The gateway 200 transmits the measurements to the computer-based program 300 through the network 500 using an Ethernet or cellular internet connection.

The computer-based program 300 is configured for processing measurements and metadata using computer readable software code to display measurement data in a digestible and analytical manner. The computer-based program 300 runs on a computer system 302. The computer system 302 may include one or more computing devices, such as servers, nodes, or computers. Further, the computing device may include one or more processing elements 304 (e.g., processors, central processing unit (CPU)) and some form of memory 306 (e.g., data storage device, database), the memory being connected to (e.g., communicatively coupled with) the processing element(s). The computing device may further include one or more user interface devices (e.g., user input devices), such as a keyboard, mouse, display, and/or the like, which are connected to (e.g., communicatively coupled with) the processing element(s). As used herein, the term “server” may refer to software (and suitable computer hardware) which is configured for providing (or helping to provide) a network service. For example, the term “server” may refer to software which is executed on a dedicated computer (e.g., hosted by a networked computer). Further, the term “server” may refer to the dedicated computer itself. Further, the term “server” may refer to a computer program which may execute to service the requests of other computer programs. The computer system 302 is communicatively coupled to the network 500. The network 500 may implement the internet.

FIG. 1.a. represents a distance sensor network where the plurality of distance sensors 100 transmit measurements and accompanying metadata to a gateway 200. The gateway 200 receives the measurements and accompanying metadata, and transmits the same to the computer based program 300.

FIG. 2 represents a vertical cross section view of a distance sensor 100. The distance sensor 100 includes an enclosure 104, a dust tube 102, a laser module 106, a CPU 108, a battery holder 110, batteries 112, and a LoRa communicator 116. The enclosure 104 of the distance sensor 100 houses the batteries 112, the battery holder 110, the CPU 108, a LoRa modem 128 of the LoRa communicatory 116, and the laser module 106. The enclosure 104 includes a dust tube receiver 118 and may include a lid 114. The enclosure 104 may be formed as a single piece. The enclosure 104 preferably is formed with the removably attached lid 114, where the lid 114 may be removed to access the components housed within the enclosure 104. The enclosure 104 may be formed from any noncorrosive material, such as metal, metal composite, rigid plastics (e.g. high density polyethylene) or the like. The dust tube receiver 118 of the enclosure 104 is configured to receive the dust tube 102.

The dust tube 102 of the distance sensor 100 is a means for minimizing laser diffusion and preventing environmental factors from obfuscating the laser for accurate and reliable measurements, these functions being provided by the structure of the dust tube 102. The dust tube 102 may be any elongate shape, such as a cylinder (FIG. 3.b.) or a funnel (FIG. 3.a.), with an opening on each end of the dust tube 102 such that the laser module 106 may take an unimpeded measurement (i.e. the structure of the dust tube 102 does not impede the path of the laser). The dust tube 102 may be formed of any non-corrosive material, such as metal, metal composite, rigid plastics (e.g. high density polyethylene), and the like.

The dust tube 102 includes a mount receiver 120, an enclosure attachment 134, a diameter 122 and a length 124. The mount receiver 120 is configured for removable attachment to the mount 126, such as through threaded communication, friction communication, or the like. Preferably, the mount receiver 120 is removably attached through 1.5 national pipe threaded communication. The enclosure attachment 134 of the dust tube 102 is received by the dust tube receiver 118 of the enclosure 104. The enclosure attachment 134 may be received in fixed communication with the dust tube receiver 118, such as through gluing, welding, or forming as a part of the enclosure 104. Preferably, the enclosure attachment 134 of the dust tube 102 is in removably fixed communication with the dust tube receiver 118, such as through threaded communication, friction communication, or the like.

The diameter 122 of the dust tube 102 is from 0.635 centimeters (cm) to 7.62 cm (0.25 to 3 inches) (measured at the opening of the dust tube 102 nearest to the aggregate). Preferably the diameter of the dust tube 102 is from 1.27 cm to 6.35 cm (0.5 to 2.5 inches). Most preferably, the diameter 122 of the dust tube is from 2.54 cm to 5.08 cm (1 to 2 inches). The length 124 of the dust tube 102 is from 2.54 cm to 60.96 cm (1 to 24 inches) (measured from the opening of the dust tube nearest to the aggregate to a point of attachment between the dust tube 102 and the enclosure 104, identified as 124a on FIG. 2). Preferably, the length of the dust tube 102 is from 10.16 cm to 50.8 cm (4 to 20 inches) in length. Most preferably, the dust tube 102 is from 20.32 cm to 40.64 cm (8 to 16 inches) in length.

The ratio of the length 124 to the diameter 122 of the dust tube 102 minimizes laser diffusion and prevents environmental factors from obfuscating the laser for accurate and reliable measurements. The ratio of the length 124 to the diameter 122 may be from 4:1 to 8:1. For example, a dust tube without a ratio of the length 124 to the diameter 122 described herein may experience diffusion of the laser such that an accurate measurement is not possible, or the laser may see environmental factors obfuscate the laser, such that a reliable measurement is not possible. The ratio of the dust tube 102 creates an atmospheric stilling effect that prevents particulate from entering the dust tube 102 in a density that would diffuse the laser from the laser module preventing an accurate measurement. Further, the ratio of the dust tube 102 creates an unattractive habitat for environmental factors (e.g. spiders and spider webs) such that these factors do not congregate within the dust tube 102.

The ratio for the dust tube 102 to minimize laser diffusion and prevent environmental factors from obfuscating the laser is selected based on the nature of the aggregate stored in the container and the container itself. For example, density of particulate (i.e. number of particulates in a volume of air) and the velocity of the particulates in the container are considerations for selection of the proper ratio for the dust tube 102. Aggregate that produces higher density particulate (e.g. particulate from cement powder, fly ash (burnt coal), or unwashed corn/grain) requires a larger ratio (e.g. from 6:1 to 8:1), whereas aggregate that produces lower density particulate (e.g. particulate from plastic pellets, washed corn) requires a lower ratio (e.g. from 4:1 to 6:1). Further containers that have higher velocity movement of particulate require a larger ration (e.g. from 6:1 to 8:1), whereas aggregate that produces lower velocity movement of particulate requires a smaller ratio (e.g. from 4:1 to 6:1).

The battery holder 110 of the distance sensor 100 is configured to hold the batteries 112. The batteries 112 of the distance sensor 100 power the distance sensor 100 for at least three years without replacement. For example, the batteries 112 may be lithium batteries.

The laser module 106 of the distance sensor 100 takes a measurement (i.e. distance from the laser 132 to the aggregate). The laser module includes a laser 132 and a laser storage medium 136. The laser 132 is a laser diode and is capable of taking measurement up to 35 feet. The laser storage medium 136 may be an electrically erasable programmable read-only memory (EEPROM), a magnetic, optical, or semi-conductor memory, another storage device, or the like. The laser storage medium 136 preferably stores the measurement until the next measurement is initiated. For example, the laser module 106 may be a conventional laser rangefinder module, such as a Bosch GLM 10 X, Bosch GLM 10, or the Precaster HP20. The laser module 106 is in electrical communication with the batteries 112 for power. The laser module 106 is communicatively coupled with the CPU 108.

The CPU (computer processing unit) 108 of the distance sensor 100 is configured to control the distance sensor 100, including to initiate the laser module 106 to take measurements at periodic intervals (e.g. once per hour) and process such measurements. The CPU 108 may be a microprocessor. The CPU 108 includes a processor 502 and a storage medium 504 (on FIG. 2 the CPU is denoted by 108 pointing to the rectangular board, where the processor 502, storage medium 504, and LoRa modem 128, and optionally the temperature sensing chip 506 reside thereon). The CPU 108 may include a temperature sensing chip 506 for determining ambient (i.e. air temperature surrounding the CPU) temperature.

The storage medium 504 of the CPU 108 may be an electrically erasable programmable read-only memory (EEPROM), a magnetic, optical, or semi-conductor memory, another storage device, or the like. The storage medium 504 may be a fixed memory device, a removable memory device, such as a memory card, remotely accessed, or the like. Preferably, the storage medium 504 is an EEPROM and is fixed in the CPU 108, where the EEPROM memory stores information without erasure in conditions where power is not supplied to the CPU 108. In this way, measurements received from the laser module 106 and periodic measurement instructions will be retained in the event that the batteries 112 cease supplying power.

The processor 502 in response to computer readable non-transient software code and data stored in the storage medium 504 initiates the laser module 106 to take a measurement. The processor 502 may determine the environmental parameters are within acceptable limits for the laser module 106 to take a measurement. For example, the processor 502 may initiate the temperature sensing chip 506 to take the ambient temperature using computer readable non-transient software code and data stored in the storage medium 504.

Upon determining the environmental parameters are acceptable, the processor 502 engages the laser module 106 by supplying the appropriate instruction to turn the laser module 106 “on” using computer readable non-transient software code and data stored in the storage medium 504. Upon determining the laser module 106 is “on,” the processor 502 initiates the laser module 106 to take a measurement using computer readable non-transient software code and data stored in the storage medium 504. Upon determining the measurement is complete, the processor 502 queries the laser module 106 to retrieve the measurement stored in the laser storage medium 136 using computer readable non-transient software code and data stored in the storage medium 504.

Upon determining receipt of the measurement, the processor 502 determines the validity of the measurement using computer readable non-transient software code and data stored in the storage medium 504. For example, the processor 502 initiates an error checking query to the laser module to validate the measurement had sufficient laser strength within a valid range using computer readable non-transient software code and data stored in the storage medium 504. Upon determining a valid measurement, the processor 502 simultaneously or nearly simultaneously stores the measurement in the storage medium 504 and transmits the measurement to the gateway 200 using the LoRa communicator 116 by using computer readable non-transient software code and data stored in the storage medium 504.

The LoRa communicator 116 is configured to transmit measurements to the gateway 200. The LoRa communicator 116 includes a LoRa modem 128 and an antenna 130. The LoRa communicator 116 is in electrical communication with the batteries 112 and is communicatively coupled to the CPU 108. The LoRa communicator 116 transmits measurements and accompanying metadata (e.g. distance sensor 100 identification, distance sensor 100 type, measurement error code, ambient temperature, LoRa radio signal strength, signal to noise ratio (SNR) of the LoRa radio link, packet length (for error validation), date and time of measurement, and battery 112 consumption) to the gateway 200 using radio frequency transmission of up to 12 kilometers.

FIGS. 3.a. and 3.b. represent an adjustable mount 126 and FIG. 3.c. represents a fixed mount 126 of the measurement system 100 configured to removably fix the distance sensor 100 to the container (see FIG. 3.d.). The distance sensor 100 is installed on the top of the container using the mount 126 where the enclosure 104 and an upper portion of the dust tube 102 of the distance sensor 100 is outside the container 50, and the opening of the dust tube 102 is within the container 50, as illustrated in 3.d. The mount 126 may be fixed or adjustable. The mount 126 may be an adjustable mount as represented in FIGS. 3.a. and 3.b. The mount 126 may be a fixed mount, as represented in FIG. 3.c.

As shown in FIGS. 3.a. and 3.b., the adjustable mount 126 allows the distance laser 100 to be placed on a plurality of containers of different slope and a plurality of locations. For example, it may be desirable to place the distance laser 100 towards to perimeter of the container when taking measurement of aggregate that has an inconsistent flow, such that aggregate from the center flows out of the container more quickly creating a “rat hole.” Placing the distance laser at the center of the container would yield an artificially low measurement of aggregate.

An adjustable mount 126 includes a dust tube attachment 326, a swivel base 328, and a swivel plate 330. The dust tube attachment 326 is configured for removable attachment to the mount receiver 120 of the dust tube 102, such as through threaded attachment, friction attachment, or the like. The swivel base 328 is generally spherical in shape and includes an interior aperture such that the laser from the laser module 106 may pass through the swivel base 328 unimpeded to the aggregate. The swivel base 328 is in swivel communication with the swivel plate 330.

The swivel plate 330 provides mechanical attachment to the container at angles from 0 to 40 degrees, such as through bolts, rivets, screws, and the like. The swivel plate 330 is swivel communication with the swivel base 328, such as through a pin and clip mechanism, rivets, bolts, or the like. The swivel communication allows the swivel plate 330 to be adjusted from 0 to 40 degrees in relation to the dust tube 102, such that the distance sensor 100 may be installed on the top of a plurality of different containers having tops of varying slopes. The swivel plate 330 may be locked into an adjusted position with the swivel base 328. The swivel plate 330 is in removably fixed communication with the lid of the container, such that the laser module 106 may be directed generally perpendicular to the aggregate or angled to the point of aggregate intended to produce an accurate measurement. FIG. 3.d. is a graphic representation of the distance sensor 100 installed on a container having a sloped roof.

As shown in FIG. 3.c., the mount 126 may be a fixed mount. The mount 126 may be a fixed mount at varying angles, such as a 0 degrees, 5 degree, 10 degrees, or 30 degrees. The fixed mount 126 represented in FIG. 3.c. represents a mount 126 for attachment to a container roof having a 30 degree angle at the point of attachment. The fixed mount 126 includes a fixed based 338 and a fixed plate 340. The fixed base 338 is configured for removable attachment to the mount receiver 120 of the dust tube 102, such as through threaded attachment, friction attachment, or the like. The fixed base 338 is generally cylindrical in shape and includes an interior cylindrical aperture, such that the laser from the laser module 106 may pass through the fixed base 338 unimpeded to the aggregate. The fixed plate 340 of the fixed mount 126 provides mechanical attachment to the roof of the container at a fixed angle, such as through bolts, rivets, screws, and the like.

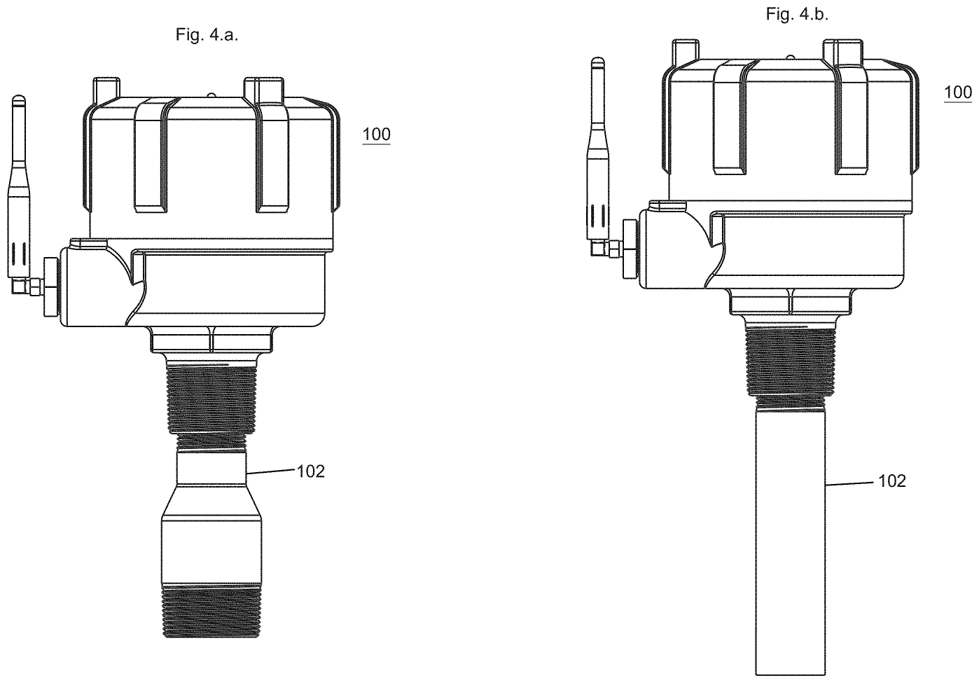

FIG. 4a represents a distance sensor having a dust tube with a funnel shape. FIG. 4b represents a distance sensor having a dust tube with a cylindrical shape.

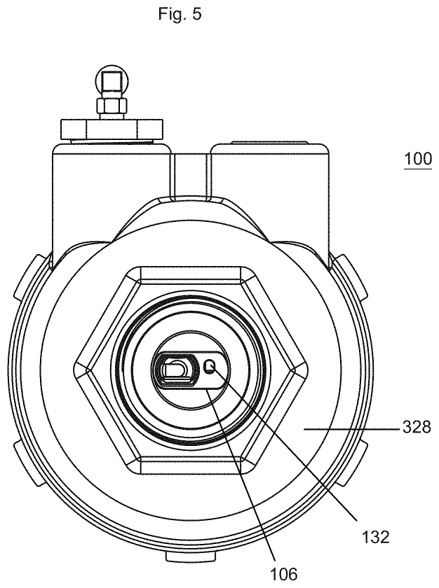

FIG. 5 is a bottom-up view of a distance sensor having a dust tube 102 in removable attachment. This view demonstrates that the laser 132 of the laser module is unimpeded by the dust tube 102 to measure the aggregate.

1. A distance sensor of a measurement system for accurate and reliable measurement of an aggregate in a container, comprising:
an enclosure configured to house a battery holder, batteries, a LoRa modem, a laser module and a CPU, the enclosure having
a removably attached lid providing access to the battery holder, batteries, LoRa modem, laser module, and CPU, and
a dust tube receiver;
a dust tube, the dust tube comprising
a mount receiver,
an enclosure attachment, wherein the enclosure attachment of the dust tube is in removable attachment with the dust tube receiver of the enclosure;
a diameter from 0.635 centimeters to 7.62 centimeters,
a length from 10.16 centimeters to 50.8 centimeters, wherein
a ratio of the length and the diameter is from 4:1 to 8:1;
a mount configured to provide mechanical attachment to a roof of the container and mechanical attachment to the dust tube via the mount receiver;
the laser module configured to measure the distance from the laser module to an aggregate of the container;
the CPU configured to initiate the laser module to measure the distance from the laser module to the aggregate of the container and transmit the measure via a LoRa communicator, wherein
the CPU is in electrical communication with the batteries and the CPU is communicatively coupled to the laser module and the LoRa communicator.

2. The distance sensor of claim 1,
wherein the ratio of the length to the diameter is from 4:1 to 6:1.

3. The distance sensor of claim 1,
wherein the ration of the length to the diameter is from 6:1 to 4:1.

4. The distance sensor of claim 1,
wherein the dust tube is spherical.

5. The distance sensor of claim 1,
wherein the dust tube is a funnel shape.

6. The distance sensor of claim 1,
wherein the mount is a fixed mount, where the angle between the fixed mount and the dust tube is selected from the group consisting of 0 degrees, 5 degrees, 10 degrees, and 30 degrees.

7. The distance sensor of claim 1,
wherein the mount is a fixed mount for attachment to a roof of the container having a 30 degree slope.

8. The distance sensor of claim 1,
wherein the mount is an adjustable mount, the adjustable mount comprising a dust tube attachment, a swivel base, and a swivel plate, where the dust tube attachment is removably attached to the mount receiver of the dust tube, the swivel base attached to the dust tube attachment, and the swivel plate and swivel base in swivel attachment,
wherein the angle between the dust tube and the swivel plate is adjustable from 0 to 40 degrees.

9. A distance sensor of a measurement system for accurate and reliable measurement of an aggregate in a container, comprising:
an enclosure configured to house a battery holder, batteries, a LoRa modem, a laser module and a CPU, the enclosure having a dust tube receiver;
a means for minimizing laser diffusion and preventing environmental factors from obfuscating the laser module, wherein
the means is in removable attachment with the enclosure via the dust tube receiver;
a mount configured to provide mechanical attachment to a roof of the container and mechanical attachment to the means via a mount receiver;
the laser module configured to measure the distance from the laser module to an aggregate of the container;
the CPU configured to initiate the laser module to measure the distance from the laser module to the aggregate of the container and transmit the measure via a LoRa communicator, wherein
the CPU is in electrical communication with the batteries and the CPU is communicatively coupled to the laser module and the LoRa communicator.

10. The distance sensor of claim 9,
wherein the mount is a fixed mount, where the angle between the fixed mount and the means is selected from the group consisting of 0 degrees, 5 degrees, 10 degrees, and 30 degrees.

11. The distance sensor of claim 9,
wherein the mount is a fixed mount for attachment to a roof of the container having a 30 degree slope.

12. The distance sensor of claim 1,
wherein the mount is an adjustable mount, the adjustable mount comprising a dust tube attachment, a swivel base, and a swivel plate, where the dust tube attachment is removably attached to the mount receiver of the means, the swivel base attached to the dust tube attachment, and the swivel plate and swivel base in swivel attachment,
wherein the angle between the dust tube and the swivel plate is adjustable from 0 to 40 degrees.

13. A measurement system for accurate and reliable measurement of an aggregate in a container, comprising:
a distance sensor, the distance sensor comprising,
an enclosure configured to house a battery holder, batteries, a LoRa modem, a laser module and a CPU, the enclosure having a dust tube receiver;
a means for minimizing laser diffusion and preventing environmental factors from obfuscating the laser module, wherein
the means is in removable attachment with the enclosure via the dust tube receiver;
a mount configured to provide mechanical attachment to a roof of the container and mechanical attachment to the means via a mount receiver;
the laser module configured to measure the distance from the laser module to an aggregate of the container;
the CPU configured to initiate the laser module to measure the distance from the laser module to the aggregate of the container and transmit the measure via a LoRa communicator, wherein
the CPU is in electrical communication with the batteries and the CPU is communicatively coupled to the laser module and the LoRa communicator;
a gateway configured to receive the measure from the LoRa communicator of the distance sensor, the gateway further configured to transmit the measure and a metadata set to a computer-based program via a network;
the computer-based program configured for processing the measure and the metadata set.

14. The measurement system of claim 13,
wherein the mount is a fixed mount, where the angle between the fixed mount and the means is selected from the group consisting of 0 degrees, 5 degrees, 10 degrees, and 30 degrees.

15. The measurement system of claim 13,
wherein the mount is a fixed mount for attachment to a roof of the container having a 30 degree slope.

16. The measurement system of claim 13,
wherein the mount is an adjustable mount, the adjustable mount comprising a dust tube attachment, a swivel base, and a swivel plate, where the dust tube attachment is removably attached to the mount receiver of the means, the swivel base attached to the dust tube attachment, and the swivel plate and swivel base in swivel attachment,
wherein the angle between the dust tube and the swivel plate is adjustable from 0 to 40 degrees.
